(19) United States
(12) Patent Application Publication
(10) Pub. No.: US 2020/0120883 A1
(43) Pub. Date: Apr. 23, 2020

(54) WHEEL-SHAPED FRAMES FOR SUPPORTING INTERCHANGEABLE AGRICULTURE AND AQUACULTURE MULTIPONIC PODS SYSTEM AND METHOD

(71) Applicant: Darren Noddle, Campbellford (CA)

(72) Inventor: Darren Noddle, Campbellford (CA)

(21) Appl. No.: 16/200,441

(22) Filed: Nov. 26, 2018

(30) Foreign Application Priority Data
Oct. 18, 2018 (CA) 3024187

(51) Int. Cl. A01G 31/04; A01G 7/04; A01G 9/02; A01G 9/12; A01G 9/14; A01G 9/20; A01G 9/24

(52) U.S. Cl. CPC A01G 31/047; A01G 7/045; A01G 9/02; A01G 9/24; A01G 9/14; A01G 9/20; A01G 9/12

(57) ABSTRACT

Wheel-shaped frames for supporting interchangeable agriculture and aquaculture multiponic pods system including wheel-shaped frames for supporting interchangeable agriculture and aquaculture multiponic pods assembly having a frame including; a hub; a plurality of spokes; a circular support framework; and a plurality of pods. The hub is located in a center position of the circular support framework and the plurality of spokes are connected between at an outer circumference of the hub and the plurality of pods, supported by the circular support framework. Each of the plurality of spokes is connected to a respective one of the plurality of pods. The frame rotates about a center axis of the hub; and the plurality of pods support live organisms to sustain an eco-system conducive to supplying sustainable food and sustainable energy sources for generating electrical and mechanical power.

### BACKGROUND OF THE INVENTION

This application claims benefit under 35 USC 119 to Canada National Application Serial No. 3,024,187 filed Oct. 18, 2018 the disclosure of which is incorporated herein by reference in its entirety. The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of plant husbandry of existing art and more specifically relates to stand for holding a plant or growing medium receptacle.

### RELATED ART

The conventional farming process is very labor intensive requiring manual maintenance of planting, harvesting and soil replenishment. Many herbicides and pesticides are used to control the environment, so the crops are able to grow to maturity for harvesting. Additionally, farms require large amounts of land and space to produce enough resources to be economically viable. As populations increase the land available for production is becoming more and more limited. The land and means for producing crops need to be made efficient in use. Fishing and other industries may be becoming limited as well as to space. Much of the environment becomes polluted if not managed properly. A sustainable and efficient means for feeding large populations is desired.

U.S. Pub. No. 2014/0013664 to Supawadee Mem Tesin relates to a vertical farming turbine. The described vertical farming turbine includes a ferrous wheel framework used to grow farming crops. This vertical farming method allows for less land usage, less machinery, less water usage, fewer pesticides and provides a new form of renewable energy.

### SUMMARY OF THE INVENTION

In view of the foregoing disadvantages inherent in the known plant husbandry art, the 1⁵1 present disclosure provides a novel wheel-shaped frames for supporting interchangeable agriculture and aquaculture multiponic pods system. The general purpose of the present disclosure, which will be described subsequently in greater detail, is to provide efficient and effective wheel-shaped frames for supporting interchangeable agriculture and aquaculture multiponic pods system, entitled SAFFE™.

Wheel-shaped frames for supporting interchangeable agriculture and aquaculture multiponic pods system is disclosed herein comprising: a wheel-shaped frames for supporting interchangeable agriculture and aquaculture multiponic pods assembly comprising: a frame including a hub; a plurality of spokes; a circular support framework; and a plurality of pods. The wheel-shaped frames for supporting interchangeable agriculture and aquaculture multiponic pods system comprises the wheel-shaped frames for supporting interchangeable agriculture and aquaculture multiponic pods assembly. The wheel-shaped frames for supporting interchangeable agriculture and aquaculture multiponic pods assembly comprises in functional combination the frame, the frame defined by the hub, the plurality of spokes, the circular support framework, and the plurality of pods. The hub is located in a center position of the circular support framework and the plurality of spokes are connected between at an outer circumference of the hub and the plurality of pods, supported by the circular support framework. Each one of the plurality of spokes is connected to a respective one of the plurality of pods. The frame rotates about a center axis of the hub; and the plurality of pods support live organisms to sustain an eco-system conducive to supplying sustainable food and sustainable energy sources for generating electrical and mechanical power. The device may also be symbolic if in a larger form wherein for example the pods may be large pools of water for example connected via cannels in a land mass.

A method of use for the wheel-shaped frames for supporting interchangeable agriculture and aquaculture multiponic pods system is also disclosed herein; the method comprising the steps of: providing the wheel-shaped frames for supporting interchangeable agriculture and aquaculture multiponic pods assembly comprising; a frame including; a hub; a plurality of spokes; a circular support framework; and a plurality of pods; filling the plurality of pods with live organisms to sustain an eco-system conducive to supplying sustainable food and sustainable energy sources for generating electrical and mechanical power; and operating the wheel-shaped frames for supporting interchangeable agriculture and aquaculture multiponic pods system. The method may further comprise the step of interchanging the plurality of pods as desired.

For purposes of summarizing the invention, certain aspects, advantages, and novel features of the invention have been described herein. It is to be understood that not necessarily all such advantages may be achieved in accordance with any one embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, wheel-shaped frames for supporting interchangeable agriculture and aquaculture multiponic pods system, constructed and operative according to the teachings of the present disclosure.

FIG. 1 is a perspective view of the wheel-shaped frames for supporting interchangeable agriculture and aquaculture multiponic pods system during an ‘in-use’ condition, according to an embodiment of the disclosure.

FIG. 2 is a perspective view of the wheel-shaped frames for supporting interchangeable agriculture and aquaculture multiponic pods system of FIG. 1, according to an embodiment of the present disclosure.

FIG. 3 is a perspective view of the wheel-shaped frames for supporting interchangeable agriculture and aquaculture multiponic pods system of FIG. 1, according to an embodiment of the present disclosure.

FIG. 4 is a perspective view of the wheel-shaped frames for supporting interchangeable agriculture and aquaculture multiponic pods system of FIG. 1, according to an embodiment of the present disclosure.

FIG. 5 is a flow diagram illustrating a method of use for the wheel-shaped frames for supporting interchangeable agriculture and aquaculture multiponic pods system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a plant husbandry and more particularly to a stand for holding a plant or growing medium receptacle as used to improve the provide efficient and effective wheel-shaped frames for supporting interchangeable agriculture and aquaculture multiponic pods system, entitled SAFFE™.

Generally, the present invention comprises sustainable energy sources for generating electrical and mechanical power. The motors may comprise magnet-driven motors, compression-driven motors, gravity-weight motors, geothermal heat pumps, steam turbines, piezoelectric wave energy harvesters, waterwheel turbines, photovoltaic solar panels and wind turbines. The system has wheel-shaped frames for supporting interchangeable agriculture and aquaculture planters and enclosures therefore. The climate-controlled planter pods, electrical and mechanical energy producing systems (namely turbines and motors driven via natural forces such as wind, flowing/falling water and naturally occurring steam, solar panels, piezoelectric mechanical compression to electricity converters and thermoelectric heat to electricity converter tiles) are used within the present system to produce food, minimize environmental impact and mitigates damage caused from chemicals, radioactive pollutants (if present) in such a manner as to sustain optimum working and living environments for humans and domesticated animals.

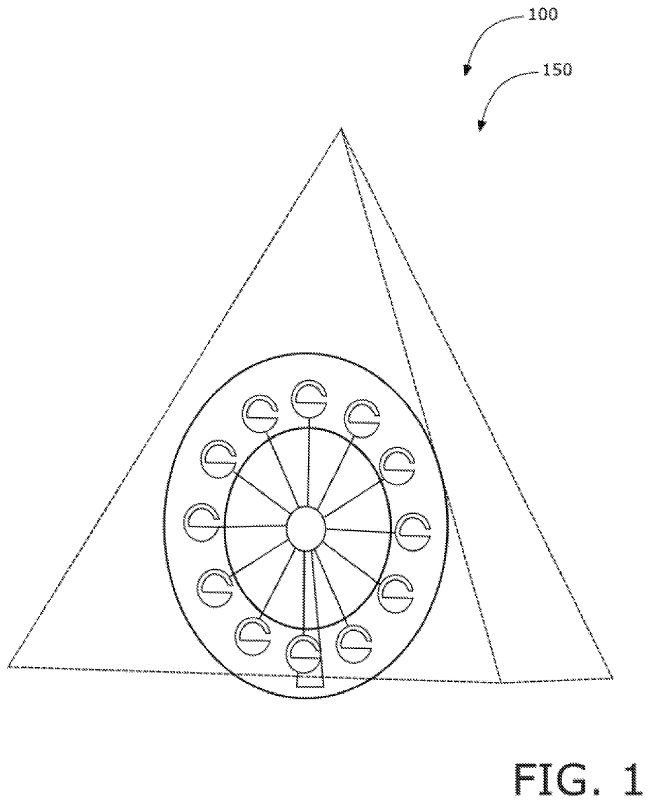

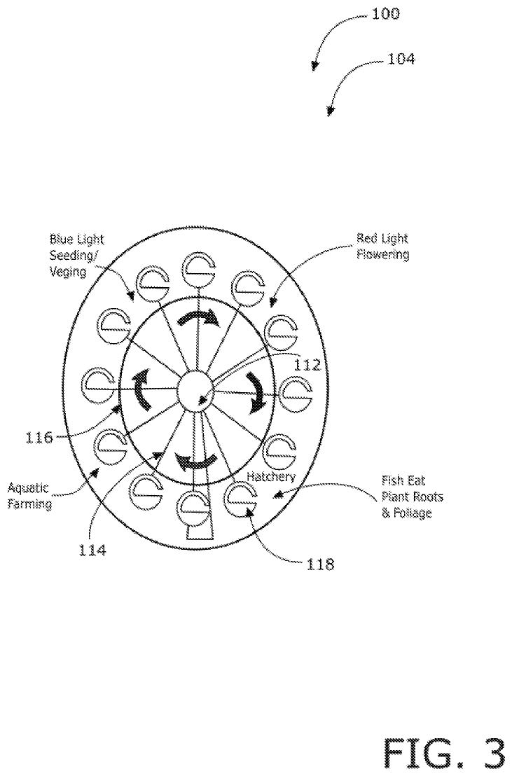

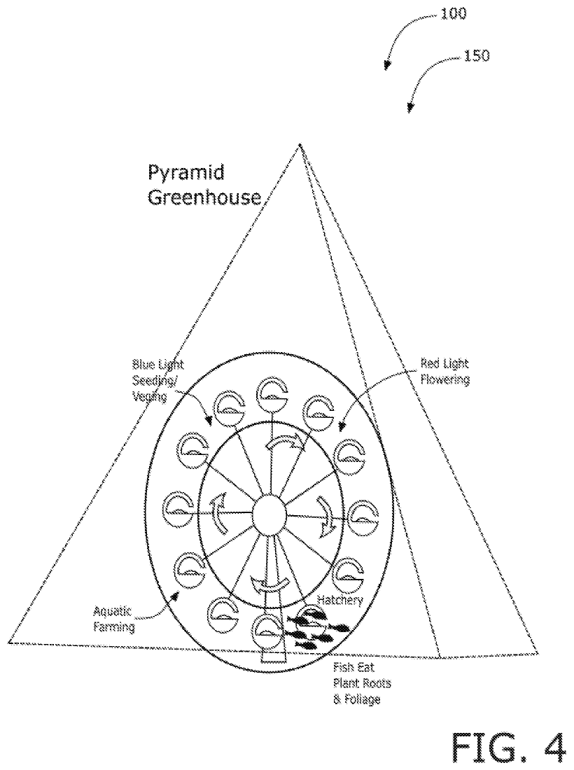

Referring now more specifically to the drawings by numerals of reference, there is shown in FIGS. 1-4, various views of a wheel-shaped frames for supporting interchangeable agriculture and aquaculture multiponic pods system 100.

FIG. 1 shows a wheel-shaped frames for supporting interchangeable agriculture and aquaculture multiponic pods system 100 during an ‘in-use’ condition 150, according to an embodiment of the present disclosure. Here, the wheel-shaped frames for supporting interchangeable agriculture and aquaculture multiponic pods system 100 may be beneficial for use by a user/entity to provide efficient and effective support for interchangeable agriculture and aquaculture.

As illustrated, the wheel-shaped frames for supporting interchangeable agriculture and aquaculture multiponic pods system 100 may include a wheel-shaped frames for supporting interchangeable agriculture and aquaculture multiponic pods assembly 104 comprising; a frame 110 including; a hub 112; a plurality of spokes 114; a circular support framework 116; and a plurality of pods 118. The wheel-shaped frames for supporting interchangeable agriculture and aquaculture multiponic pods system 100 comprises the wheel-shaped frames for supporting interchangeable agriculture and aquaculture multiponic pods assembly 104. Certain embodiments may comprise a pyramid greenhouse as shown.

The wheel-shaped frames for supporting interchangeable agriculture and aquaculture multiponic pods assembly 104 comprises in functional combination the frame 110; the frame defined by the hub 112, the plurality of spokes 114, the circular support framework 116, and the plurality of pods 118. The hub 112 is located in a center position of the circular support framework 116, and the plurality of spokes 114 are connected between at an outer circumference of the hub 112 and the plurality of pods 118, supported by the circular support framework 116. Each of each of the plurality of spokes 114 is connected to a respective one of the plurality of pods 118, and the frame 110 rotates about a center axis of the hub 112. The plurality of pods 118 supports live organisms to sustain an eco-system conducive to supplying sustainable food and sustainable energy sources for generating electrical and mechanical power.

According to one embodiment, the wheel-shaped frames for supporting interchangeable agriculture and aquaculture multiponic pods system 100 may be arranged as a kit. In particular, the wheel-shaped frames for supporting interchangeable agriculture and aquaculture multiponic pods system 100 may further include a set of instructions. The instructions may detail functional relationships in relation to the structure of the wheel-shaped frames for supporting interchangeable agriculture and aquaculture multiponic pods system 100 such that the wheel-shaped frames for supporting interchangeable agriculture and aquaculture multiponic pods system 100 can be used, maintained, or the like, in a preferred manner.

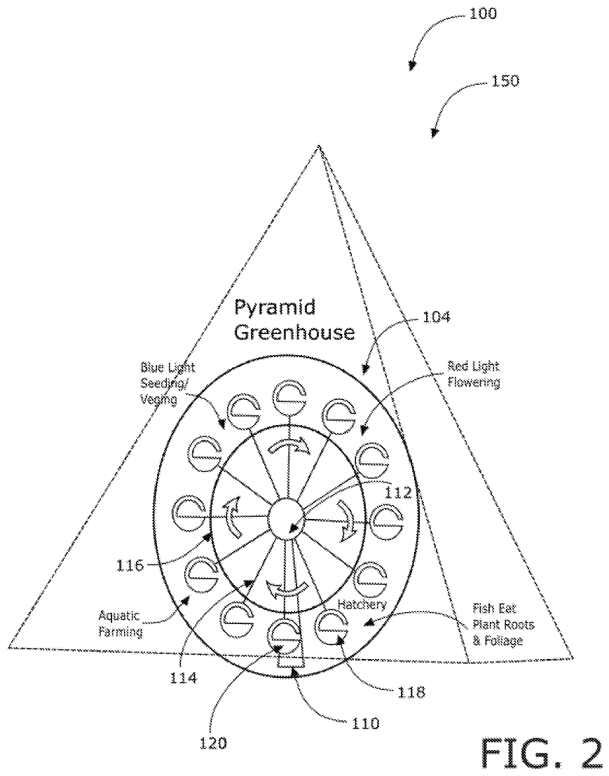

Referring now to FIGS. 2-4 showing various views of the wheel-shaped frames for supporting interchangeable agriculture and aquaculture multiponic pods system 100 of FIG. 1, according to an embodiment of the present disclosure.

Referring now to the plurality of pods 118; the plurality of pods 118 preferably comprise climate-controlled planter pods 120. The wheel-shaped frames for supporting interchangeable agriculture and aquaculture multiponic pods system 100 may further comprise a motor; the motor provides a means to rotate the wheel-shaped frames for supporting interchangeable agriculture and aquaculture multiponic pods assembly 104. The wheel-shaped frames for supporting interchangeable agriculture and aquaculture multiponic pods system 100 wherein the motor may comprise a magnet-driven-motor, a compression-driven-motor or a gravity-weight-motor. The devices may be connected in series or in parallel. As shown in FIG. 2, red light may be used for flowering; and fish in a hatchery are able to eat plant roots and foliage. In the cycle aquatic farming may be used. Blue light seeding/veging may be found in the cycle as well, as shown. The direction of travel (and time) is indicated by directional arrows.

The wheel-shaped frames for supporting interchangeable agriculture and aquaculture multiponic pods system 100 may further comprise incorporation of and use of at least one geothermal heat pump, and at least one steam turbine. Additionally, the wheel-shaped frames for supporting interchangeable agriculture and aquaculture multiponic pods system 100 may comprise at least one piezoelectric wave energy harvester, and at least one waterwheel turbine. Further, the system 100 may comprise at least one photovoltaic solar panel, and at least one wind turbine. These particular additional devices may be used all together or in various combinations as to fit the particular application required. In this way the present invention is environmentally-friendly and doesn't leave a ‘footprint’, but rather sustains the natural environment and provides as sustainable food source.

The plurality of pods 118 comprise the climate-controlled planter pods 120 which are interchangeable. The wheel-shaped frames for supporting interchangeable agriculture and aquaculture multiponic pods system 100 functions to mitigate damage caused from chemicals and pollutants.

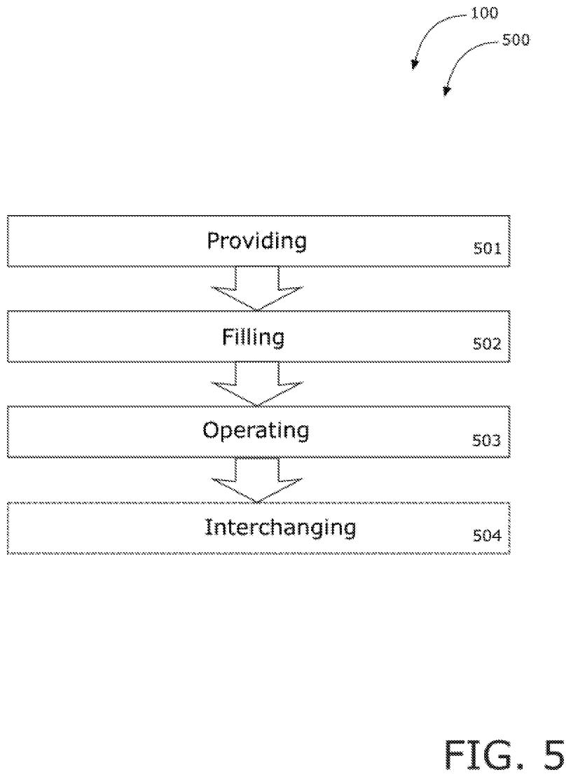

Referring now to FIG. 5 showing a flow diagram illustrating a method of use 500 for wheel-shaped frames for supporting interchangeable agriculture and aquaculture multiponic pods system 100, according to an embodiment of the present disclosure. In particular, the method of use 500 may include one or more components or features of the wheel-shaped frames for supporting interchangeable agriculture and aquaculture multiponic pods system 100 as described above. As illustrated, the method of use 500 may include the steps of: step one 501, providing a wheel-shaped frames for supporting interchangeable agriculture and aquaculture multiponic pods assembly comprising; a frame including; a hub; a plurality of spokes; a circular support framework; and a plurality of pods; step two 502, filling the plurality of pods with live organisms to sustain an eco-system conducive to supplying sustainable food and sustainable energy sources for generating electrical and mechanical power; step three 503, operating the wheel-shaped frames for supporting interchangeable agriculture and aquaculture multiponic pods system; step four 504, interchanging the plurality of pods as desired. Monitoring may be performed as needed.

It should be noted that step 504 is an optional step and may not be implemented in all cases. Optional steps of method of use 500 are illustrated using dotted lines in FIG. 5 to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods to improve and provide efficient and effective wheel-shaped frames for supporting interchangeable agriculture and aquaculture multiponic pods system, entitled SAFFE, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A wheel-shaped frames for supporting interchangeable agriculture and aquaculture multiponic pods system comprising:
a wheel-shaped frames for supporting interchangeable agriculture and aquaculture multiponic pods assembly comprising;
a frame including;
a hub;
a plurality of spokes;
a circular support framework; and
a plurality of pods;
wherein said wheel-shaped frames for supporting interchangeable agriculture and aquaculture multiponic pods system comprises said wheel-shaped frames for supporting interchangeable agriculture and aquaculture multiponic pods assembly
wherein said wheel-shaped frames for supporting interchangeable agriculture and aquaculture multiponic pods assembly comprises in functional combination said frame, said frame defined by said hub, said plurality of spokes, said circular support framework, and said plurality of pods;
wherein said hub is located in a center position of said circular support framework;
wherein said plurality of spokes are connected between at an outer circumference of said hub and said plurality of pods, supported by said circular support framework;
wherein each of said plurality of spokes is connected to a respective one of said plurality of pods;
wherein said frame rotates about a center axis of said hub; and
wherein said plurality of pods support live organisms to sustain an eco-system conducive to supplying sustainable food and sustainable energy sources for generating electrical and mechanical power.

2. The wheel-shaped frames for supporting interchangeable agriculture and aquaculture multiponic pods system of claim 1, wherein said plurality of pods comprise climate-controlled planter pods.

3. The wheel-shaped frames for supporting interchangeable agriculture and aquaculture multiponic pods system of claim 2, further comprising a motor, said motor providing a means to rotate said wheel-shaped frames for supporting interchangeable agriculture and aquaculture multiponic pods assembly.

4. The wheel-shaped frames for supporting interchangeable agriculture and aquaculture multiponic pods system of claim 3, wherein said motor comprises a magnet-driven-motor.

5. The wheel-shaped frames for supporting interchangeable agriculture and aquaculture multiponic pods system of claim 3, wherein said motor comprises a compression-driven-motor.

6. The wheel-shaped frames for supporting interchangeable agriculture and aquaculture multiponic pods system of claim 3, wherein said motor comprises a gravity-weight-motor.

7. The wheel-shaped frames for supporting interchangeable agriculture and aquaculture multiponic pods system of claim 3, further comprising at least one geothermal heat pump.

8. The wheel-shaped frames for supporting interchangeable agriculture and aquaculture multiponic pods system of claim 3, further comprising at least one steam turbine.

9. The wheel-shaped frames for supporting interchangeable agriculture and aquaculture multiponic pods system of claim 3, further comprising at least one piezoelectric wave energy harvester.

10. The wheel-shaped frames for supporting interchangeable agriculture and aquaculture multiponic pods system of claim 3, further comprising at least one waterwheel turbine.

11. The wheel-shaped frames for supporting interchangeable agriculture and aquaculture multiponic pods system of claim 3, further comprising at least one photovoltaic solar panel.

12. The wheel-shaped frames for supporting interchangeable agriculture and aquaculture multiponic pods system of claim 3, further comprising at least one wind turbine.

13. The wheel-shaped frames for supporting interchangeable agriculture and aquaculture multiponic pods system of claim 2, wherein said plurality of pods comprising said climate-controlled planter pods are interchangeable.

14. The wheel-shaped frames for supporting interchangeable agriculture and aquaculture multiponic pods system of claim 1, wherein the wheel-shaped frames for supporting interchangeable agriculture and aquaculture multiponic pods system functions to mitigate damage caused from chemicals.

15. The wheel-shaped frames for supporting interchangeable agriculture and aquaculture multiponic pods system of claim 1, wherein the wheel-shaped frames for supporting interchangeable agriculture and aquaculture multiponic pods system functions to mitigate damage caused from pollutants.

16. The wheel-shaped frames for supporting interchangeable agriculture and aquaculture multiponic pods system of claim 1, comprises a plurality of said wheel-shaped frames for supporting interchangeable agriculture and aquaculture multiponic pods assemblies.

17. A wheel-shaped frames for supporting interchangeable agriculture and aquaculture multiponic pods system comprising:
a wheel-shaped frames for supporting interchangeable agriculture and aquaculture multiponic pods assembly comprising;
a frame including;
a hub;
a plurality of spokes;
a circular support framework; and
a plurality of pods;
wherein said wheel-shaped frames for supporting interchangeable agriculture and aquaculture multiponic pods system comprises said wheel-shaped frames for supporting interchangeable agriculture and aquaculture multiponic pods assembly
wherein said wheel-shaped frames for supporting interchangeable agriculture and aquaculture multiponic pods assembly comprises in functional combination said frame, said frame defined by said hub, said plurality of spokes, said circular support framework, and said plurality of pods;
wherein said hub is located in a center position of said circular support framework;
wherein said plurality of spokes are connected between at an outer circumference of said hub and said plurality of pods, supported by said circular support framework;
wherein each of said plurality of spokes is connected to a respective one of said plurality of pods;
wherein said frame rotates about a center axis of said hub;
wherein said plurality of pods comprise climate-controlled planter pods;
further comprising a motor, said motor providing a means to rotate said wheel-shaped frames for supporting interchangeable agriculture and aquaculture multiponic pods assembly;
wherein said motor comprises a magnet-driven-motor;
wherein said plurality of pods comprising said climate-controlled planter pods are interchangeable;
wherein the wheel-shaped frames for supporting interchangeable agriculture and aquaculture multiponic pods system functions to mitigate damage caused from chemicals and pollutants; and
wherein said plurality of pods support live organisms to sustain an eco-system conducive to supplying sustainable food and sustainable energy sources for generating electrical and mechanical power.

18. The wheel-shaped frames for supporting interchangeable agriculture and aquaculture multiponic pods system of claim 17, further comprising set of instructions; and
wherein the wheel-shaped frames for supporting interchangeable agriculture and aquaculture multiponic pods system is arranged as a kit.

19. A method of use for the wheel-shaped frames for supporting interchangeable agriculture and aquaculture multiponic pods system, the method comprising the steps of:
providing a wheel-shaped frames for supporting interchangeable agriculture and aquaculture multiponic pods assembly comprising;
a frame including;
a hub;
a plurality of spokes;
a circular support framework; and
a plurality of pods;
filling said plurality of pods with live organisms to sustain an eco-system conducive to supplying sustainable food and sustainable energy sources for generating electrical and mechanical power; and
operating said wheel-shaped frames for supporting interchangeable agriculture and aquaculture multiponic pods system.

20. The method of claim 19, further comprising the step of interchanging a portion of said plurality of pods as desired.
